(19) United States
(12) Patent Application Publication
(10) Pub. No.: US 2025/0111844 A1
(43) Pub. Date: Apr. 3, 2025

(54) INFORMATION PROCESSING DEVICE, ELECTRONIC MUSICAL INSTRUMENT, ELECTRONIC MUSICAL INSTRUMENT SYSTEM, METHOD, AND STORAGE MEDIUM

(71) Applicant: CASIO COMPUTER CO., LTD., Shibuya-ku, Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Shibuya-ku, Tokyo (JP)

(21) Appl. No.: 18/729,842

(22) PCT Filed: Jan. 11, 2023
(86) PCT No.: PCT/JP2023/000399

§ 371 Date: Jul. 17, 2024

(30) Foreign Application Priority Data
Jan. 19, 2022 (JP) 2022-006321

(51) Int. Cl. G10L 13/02; G10H 1/00

(52) U.S. Cl. CPC G10L 13/02; G10H 1/0033

(57) ABSTRACT

An information processing device includes a controller. In response to detection of an operation on an operator, the controller causes sound emission of a syllable to start based on a parameter for a syllable start frame. In a case where the operation continues even after start of sound emission of a vowel based on a parameter for a vowel frame in a vowel section included in the syllable, the controller causes the sound emission of the vowel based on the parameter for the vowel frame to continue until the operation is released.

### TECHNICAL FIELD

The present invention relates to an information processing device, an electronic musical instrument, an electronic musical instrument system, a method, and a program.

### BACKGROUND ART

There is known a conventional technique of pronouncing lyrics syllable by syllable in response to pressed keys of an electronic musical instrument, such as a keyboard instrument.

For example, in Patent Literature 1, there is disclosed an audio information playback method including reading audio information in which waveform data pieces, of a plurality of utterance units with defined pitch and order in regard to sound generation, are chronologically sequenced, reading separator information that is associated with the audio information and that defines a playback start position, a loop start position, a loop end position, and a playback end position in regard to each utterance unit, moving a playback position in the audio information based on the separator information in response to acquisition of note-on information or note-off information, and starting playback from the loop end position to the playback end position of an utterance unit subject to playback in response to acquisition of the note-off information corresponding to the note-on information.

### CITATION LIST

### Patent Literature

Patent Literature 1: WO 2020/217801 A1

### SUMMARY OF INVENTION

### Technical Problem

However, in Patent Literature 1, pieces of audio information, which are waveform data pieces of utterance units, are joined together for syllable-by-syllable pronunciation and loop playback, making it difficult to emit a natural singing voice. Further, since audio information, in which waveform data pieces of a plurality of utterance units are chronologically sequenced, needs to be stored, a large memory capacity is required.

The present invention has been conceived in view of the above problems, and objects thereof include making it possible to emit a more natural sound in response to an operation(s) on an electronic musical instrument with a smaller memory capacity.

### Solution to Problem

In order to solve the above problems, an information processing device of the present invention includes a controller that, in a case where after sound emission of a syllable based on a parameter for a syllable start frame is started in response to detection of an operation on an operation element, the operation on the operation element continues even after start of sound emission of a vowel based on a parameter for a vowel frame in a vowel section included in the syllable, causes the sound emission of the vowel based on the parameter for the vowel frame to continue until the operation on the operation element is released.

### Advantageous Effects of Invention

The present invention can emit a more natural sound in response to an operation(s) on an electronic musical instrument with a smaller memory capacity.

### BRIEF DESCRIPTION OF DRAWINGS

FIG. 1 This shows an example of the overall configuration of an electronic musical instrument system of the present invention.

FIG. 2 This shows the external appearance of an electronic musical instrument shown in FIG. 1.

FIG. 3 This is a block diagram showing a functional configuration of the electronic musical instrument shown in FIG. 1.

FIG. 4 This is a block diagram showing a functional configuration of a terminal device shown in FIG. 1.

FIG. 5 This shows a configuration for emitting a singing voice in response to key press operations on a keyboard in a singing voice emission mode of the electronic musical instrument shown in FIG. 1.

FIG. 6A This illustrates a relationship between frames and syllables in an English phrase.

FIG. 6B This illustrates a relationship between frames and syllables in a Japanese phrase.

FIG. 7 This is a flowchart showing flow of a singing voice emission mode process that is performed by a CPU shown in FIG. 3.

FIG. 8 This is a flowchart showing flow of a vocal synthesis process A that is performed by the CPU shown in FIG. 3.

FIG. 9 This is a flowchart showing flow of a vocal synthesis process B that is performed by the CPU shown in FIG. 3.

FIG. 10 This is a flowchart showing flow of a vocal synthesis process C that is performed by the CPU shown in FIG. 3.

FIG. 11 This is a flowchart showing flow of a vocal synthesis process D that is performed by the CPU shown in FIG. 3.

FIG. 12A This shows a graph and a schematic view in a case where a syllable of “Come” is pronounced in response to an operation on the keyboard by the singing voice emission mode process, wherein the graph shows change in volume from when key press is detected until when key release is detected and the volume becomes zero, the schematic view shows frame positions that are used for pronunciation at respective timings in the graph, and the graph and the schematic view are those of a case where key release (release of all keys) is detected at the timing of the end position of a vowel of ah.

FIG. 12B This shows a graph and a schematic view in the case where the syllable of “Come” is pronounced in response to an operation on the keyboard by the singing voice emission mode process, wherein the graph shows change in volume from when key press is detected until when key release is detected and the volume becomes zero, the schematic view shows frame positions that are used for pronunciation at respective timings in the graph, and the graph and the schematic diagram are those of a case where key release (release of all keys) is detected after a time for three frames elapses from the timing of the end position of the vowel of ah.

FIG. 12C This shows a graph and a schematic view in the case where the syllable of “Come” is pronounced in response to an operation on the keyboard by the singing voice emission mode process, wherein the graph shows change in volume from when key press is detected until when key release is detected and the volume becomes zero, the schematic view shows frame positions that are used for pronunciation at respective timings in the graph, and the graph and the schematic view are those of a case where key release (release of all keys) is detected at a timing before the end position of the vowel of ah.

### DESCRIPTION OF EMBODIMENTS

Hereinafter one or more embodiments for carrying out the present invention will be described using the drawings. The embodiments described below are provided with various technically preferred limitations for carrying out the present invention. The technical scope of the present invention is not limited to the embodiments below or illustrated examples.

### Configuration of Electronic Musical Instrument System 1

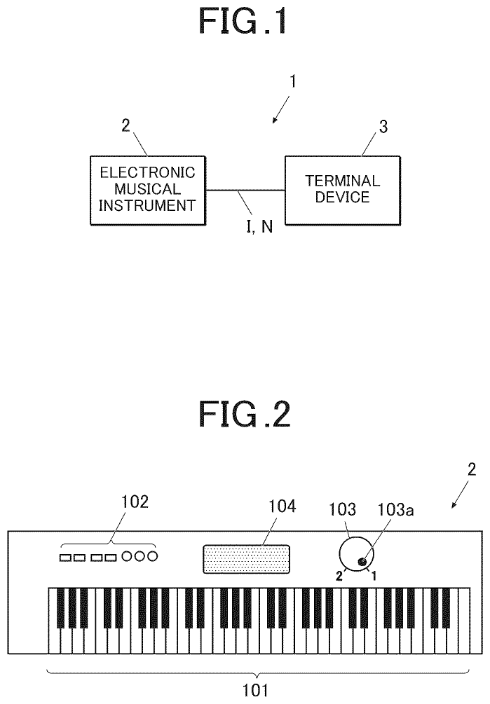

FIG. 1 shows an example of the overall configuration of an electronic musical instrument system 1 of the present invention.

As shown in FIG. 1, the electronic musical instrument system 1 includes an electronic musical instrument 2 and a terminal device 3 that are connected via a communication interface I (or communication network N).

### Configuration of Electronic Musical Instrument 2

The electronic musical instrument 2 has a normal mode to output a musical instrument sound in response to key press operations by a user on a keyboard 101 and a singing voice emission mode to emit a singing voice in response to key press operations on the keyboard 101.

In this embodiment, the electronic musical instrument 2 has a first mode and a second mode as the singing voice emission mode. The first mode is a mode to emit a singing voice faithful to a human (singer) voice. The second mode is a mode to emit a singing voice with a tone into which a set tone (musical instrument sound, etc.) and a human's singing voice are combined.

FIG. 2 shows an example of the external appearance of the electronic musical instrument 2. The electronic musical instrument 2 includes the keyboard 101 including a plurality of keys as operation elements (performance operation elements), a switch panel 102 to command various settings, a parameter change operator 103, and an LCD (Liquid Crystal Display) 104 that performs various types of display. The electronic musical instrument 2 further includes, on the back face, lateral face, rear face or the like, a speaker 214 that releases a musical instrument sound or a sound (singing voice) generated by a performance.

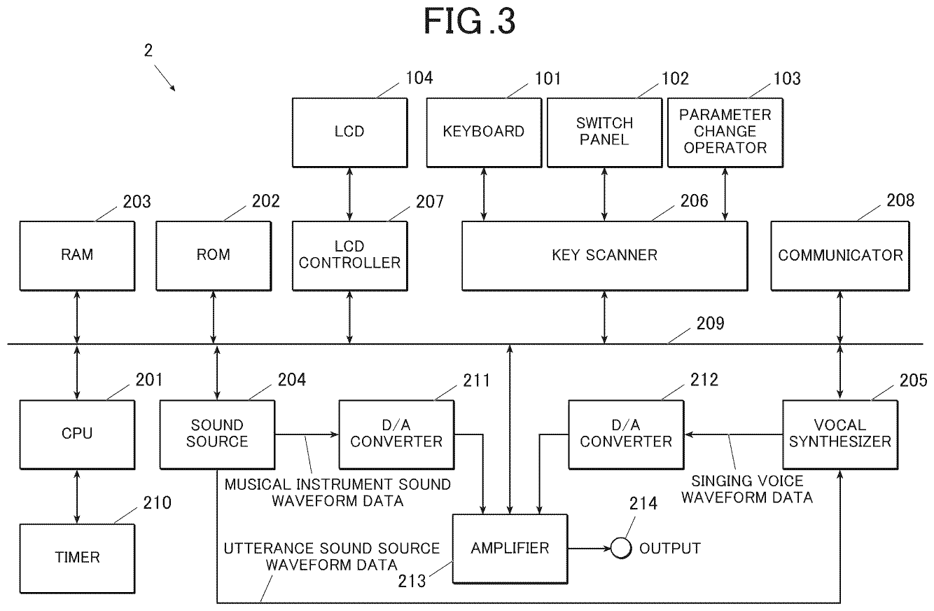

FIG. 3 is a block diagram showing a functional configuration of a control system of the electronic musical instrument 2 shown in FIG. 1. As shown in FIG. 3, the electronic musical instrument 2 includes a CPU (Central Processing Unit) 201 connected to a timer 210, a ROM (Read Only Memory) 202, a RAM (Random Access Memory) 203, a sound source 204, a vocal synthesizer 205, an amplifier 213, a key scanner 206 to which the keyboard 101, the switch panel 102 and the parameter change operator 103 shown in FIG. 2 are connected, an LCD controller 207 to which the LCD 104 shown in FIG. 2 is connected and a communicator 208 that are connected to a bus 209. In this embodiment, the switch panel 102 includes a singing voice emission mode switch, a first-mode-and-second-mode changeover switch, and a tone setting switch, which will be described later.

The sound source 204 and the vocal synthesizer 205 are connected with D/A converters 211 and 212, respectively. Waveform data of a musical instrument sound output from the sound source 204 and sound waveform data of a singing voice (singing voice waveform data) output from the vocal synthesizer 205 are converted into analog signals by the D/A converters 211 and 212, respectively, and the analog signals are amplified by the amplifier 213 and then output (i.e., emitted as sound) from the speaker 214.

The CPU 201 executes programs stored in the ROM 202 while using the RAM 203 as a work memory, thereby controlling operation of the electronic musical instrument 2 shown in FIG. 1. The CPU 201 performs a singing voice emission mode process described below in cooperation with programs stored in the ROM 202, thereby realizing functions of a controller of an information processing device of the present invention.

The ROM 202 stores programs, various fixed data and so forth.

The sound source 204 has a waveform ROM that stores waveform data of various tones of human voice, dog voice, cat voice and so forth as waveform data as utterance sound sources (utterance sound source waveform data) in the singing voice emission mode as well as waveform data of musical instrument sounds (musical instrument sound waveform data) of a piano, an organ, a synthesizer, string instruments, wind instruments and so forth. The musical instrument sound waveform data may be used as the utterance sound source waveform data.

In the normal mode, the sound source 204 reads musical instrument sound waveform data from, for example, the not-shown waveform ROM on the basis of pitch information on a pressed key of the keyboard 101 in accordance with a control command from the CPU 201, and outputs the data to the D/A converter 211. In the second mode of the singing voice emission mode, the sound source 204 reads waveform data from, for example, the not-shown waveform ROM on the basis of pitch information on a pressed key of the keyboard 101 in accordance with a control command from the CPU 201, and outputs the data to the vocal synthesizer 205 as utterance sound source waveform data. The sound source 204 is capable of outputting waveform data for a plurality of channels simultaneously. The sound source 204 may generate, on the basis of pitch information on a pressed key and waveform data stored in the waveform ROM, waveform data corresponding to the pitch of the pressed key of the keyboard 101.

The sound source 204 is not limited to using the PCM (Pulse Code Modulation) sound source method, but may use another sound source method, such as the FM (Frequency Modulation) sound source method, for example.

The vocal synthesizer 205 has a sound generator and a synthesis filter, and generates singing voice waveform data on the basis of pitch information and a singing voice parameter given from the CPU 201 or a singing voice parameter given from the CPU 201 and utterance sound source waveform data input from the sound source 204, and outputs the data to the D/A converter 212.

The sound source 204 and the vocal synthesizer 205 may be configured by dedicated hardware, such as LSI (Large-Scale Integration), or may be realized by software, namely, by the CPU 201 and programs stored in the ROM 202 working together.

The key scanner 206 regularly scans key press (KeyOn)/key release (KeyOff) of each key of the keyboard 101 shown in FIG. 2 and operation states of the switch panel 102 and the parameter change operator 103, and outputs pitch and key press/key release information (performance operation information) on each operated key of the keyboard 101 and operation information on each of the switch panel 102 and the parameter change operator 103 to the CPU 201.

The parameter change operator 103 is a switch for the user to set (make an instruction to change) a tone (voice tone) of a singing voice that is emitted in the singing voice emission mode. As shown in FIG. 2, the parameter change operator 103 of this embodiment is configured to be rotatable in a range in which the position of an indicator 103a is between a scale mark of 1 and a scale mark of 2, and according to the position of the indicator 103a, can set (change) the voice tone of the singing voice that is emitted in the singing voice emission mode between a first sound and a second sound different from the first sound. For example, turning the parameter change operator 103 clockwise to the maximum (e.g., making the indicator 103a point the scale mark of 1) can set the voice tone of the singing voice that is emitted in the singing voice emission mode to the first sound (e.g., male voice). Turning the parameter change operator 103 counterclockwise to the maximum (e.g., making the indicator 103a point the scale mark of 2) can set the voice tone of the singing voice that is emitted in the singing voice emission mode to the second sound (e.g., female sound). Making the indicator 103a of the parameter change operator 103 be between the scale mark of 1 and the scale mark of 2 can set the voice tone to a voice tone into which the first sound and the second sound are synthesized. The synthesis ratio of the first sound and the second sound is determined according to the ratio of the rotation angle from the scale mark of 1 and the rotation angle from the scale mark of 2.

The LCD controller 207 is an IC (Integrated Circuit) that controls the display state of the LCD 104.

The communicator 208 transmits and receives data to and from external devices, such as the terminal device 3, connected via the communication network N, such as the Internet, or the communication interface I, such as a USB (Universal Serial Bus) cable.

### Configuration of Terminal Device 3

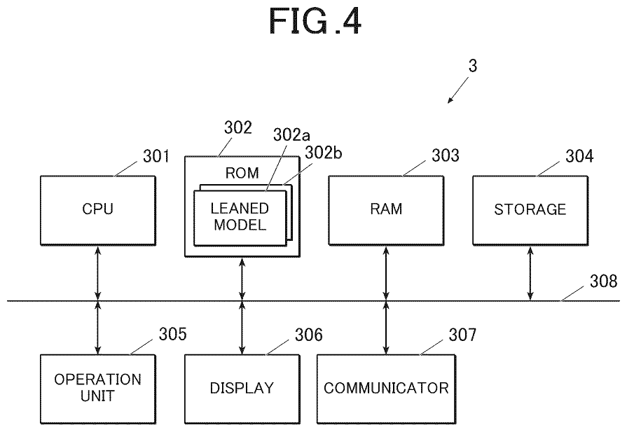

FIG. 4 is a block diagram showing a functional configuration of the terminal device 3 shown in FIG. 1.

As shown in FIG. 4, the terminal device 3 is a computer including a CPU 301, a ROM 302, a RAM 303, a storage 304, an operation unit 305, a display 306 and a communicator 307 that are connected by a bus 308. As the terminal device 3, for example, a tablet PC (Personal Computer), a laptop PC, a smartphone or the like is applicable.

The ROM 302 of the terminal device 3 is provided with a learned model 302a and a learned model 302b. The learned model 302a and the learned model 302b are each generated by machine learning of data sets made up of music score data (lyrics data (lyrics text information) and pitch data (including note length information)) of songs and singing voice waveform data of a singer (human) singing the songs. The learned model 302a is generated by machine learning of singing voice waveform data of a first singer (e.g., male) corresponding to the first sound. The learned model 302b is generated by machine learning of singing voice waveform data of a second singer (e.g., female) corresponding to the second sound. When lyrics data and pitch data of a song (or phrase) are input to the learned model 302a and the learned model 302b, each of the learned model 302a and the learned model 302b infers a group of singing voice parameters (singing voice information) for emitting a singing voice similar to that of the singer involved in generating the learned model singing the input song.

### Operation in Singing Voice Emission Mode

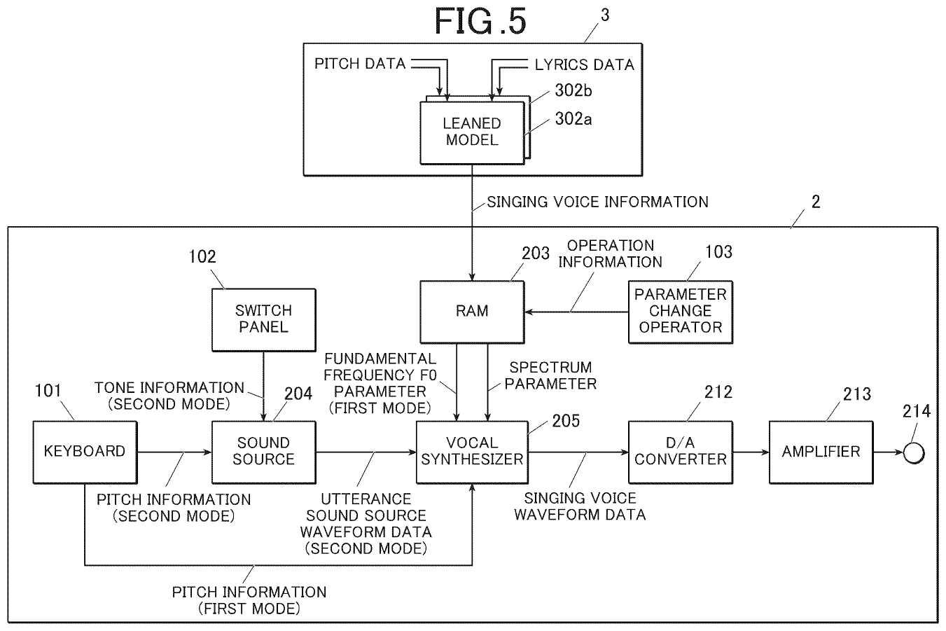

FIG. 5 shows a configuration for emitting a singing voice in response to key press operations on the keyboard 101 in the singing voice emission mode. Hereinafter, referring to FIG. 5, operation in the singing voice emission mode to emit a singing voice in response to key press operations on the keyboard 101 in the electronic musical instrument 2 will be described.

If the user wishes to play (perform) in the singing voice emission mode, the user presses the singing voice emission mode switch of the switch panel 102 of the electronic musical instrument 2 to make an instruction to shift to the singing voice emission mode.

When the singing voice emission mode switch is pressed, the CPU 201 shifts the operation mode to the singing voice emission mode. Further, the CPU 201 switches the singing voice emission mode between the first mode and the second mode in response to a press on the first-mode-and-second-mode changeover switch of the switch panel 102.

In the case where the second mode is set and the user selects, with the tone selection switch of the switch panel 102, a voice tone that the user wishes to be emitted, the CPU 201 sets information on the selected tone in the sound source 204.

Next, the user inputs, into the terminal device 3, lyrics data and pitch data of a song that the user wishes to cause the electronic musical instrument 2 to sing in the singing voice emission mode, using a dedicated application or the like. Lyrics data and pitch data of songs may be stored in the storage 304, and lyrics data and pitch data of a song may be selected from those stored in the storage 304.

When the lyrics data and the pitch data of the song that the user wishes to be sung in the singing voice emission mode are input into the terminal device 3, the CPU 301 inputs the input lyrics data and pitch data of the song to the learned model 302a and the learned model 302b, causes each of the learned models 302a and 302b to infer a group of singing voice parameters, and transmits the singing voice information that is the inferred groups of singing voice parameters to the electronic musical instrument 2 through the communicator 307.

Hereinafter the singing voice information will be described.

Segments into which a song is divided by a predetermined time unit in the time direction are called frames. The learned model 302a and the learned model 302b each generate a singing voice parameter for each frame. In other words, the singing voice information on one song generated by each learned model is made up of singing voice parameters for respective frames (group of time-series singing voice parameters). In this embodiment, the length of one sample ×225 is defined as one frame, wherein the one sample is one sample in a case where a song is sampled at a predetermined sampling frequency (e.g., 44.1 KHz).

The singing voice parameter for each frame includes a spectrum parameter (frequency spectrum of a voice to be emitted) and a fundamental frequency F0 parameter (pitch frequency of the voice to be emitted). The spectrum parameter may be expressed as a formant parameter or the like. The singing voice parameter may be expressed as a filter coefficient or the like. In this embodiment, filter coefficients to be applied to the respective frames are determined. Therefore, the present invention may be viewed as the one in which a filter is changed frame by frame.

Further, the singing voice parameter for each frame includes information on a syllable.

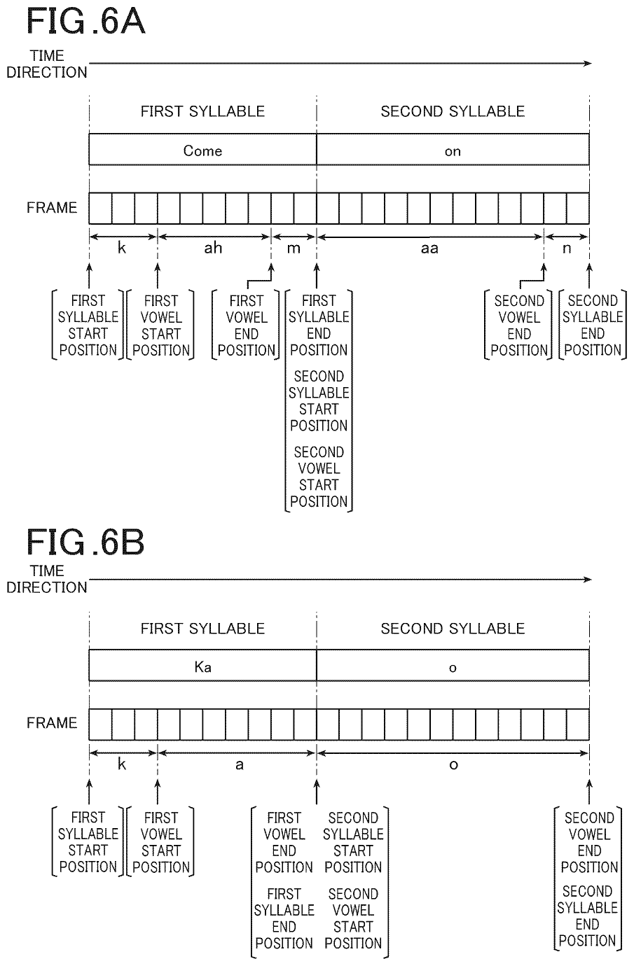

FIG. 6A and FIG. 6B each illustrate a relationship between frames and syllables. FIG. 6A illustrates a relationship between frames and syllables in an English phrase. FIG. 6B illustrates a relationship between frames and syllables in a Japanese phrase. As shown in FIG. 6A and FIG. 6B, the sound of a song (phrase) is made up of a plurality of syllables (first syllable (Come) and second syllable (on) in FIG. 6A, and first syllable (Ka) and second syllable (o) in FIG. 6B). Each syllable is typically made up of one vowel or a combination of one vowel and one or more consonants. In other words, singing voice parameters as parameters for pronouncing (emitting the sound of) a syllable include at least a parameter(s) for the vowel included in the syllable. Each syllable is pronounced over a plurality of frames/segments consecutive in the time direction, and a syllable start position, a syllable end position, a vowel start position and a vowel end position (each of which is a position in the time direction) of each syllable included in one song can be identified by frame positions (what numbers the frames are from the top). Singing voice parameters for frames respectively corresponding to the syllable start position, the syllable end position, the vowel start position and the vowel end position of each syllable in the singing voice information respectively include pieces of information such as the ◯th syllable start frame, the ◯th syllable end frame, the ◯th vowel start frame and the ◯th vowel end frame, wherein “◯” are natural numbers.

Returning to FIG. 5, in the electronic musical instrument 2, when the communicator 208 receives the singing voice information (first singing voice information generated by the learned model 302a and second singing voice information generated by the learned model 302b) from the terminal device 3, the CPU 201 stores the received singing voice information in the RAM 203.

Next, the CPU 201 sets singing voice information (group of singing voice parameters) to be used for emitting a singing voice on the basis of the operation information on the parameter change operator 103 input from the key scanner 206. More specifically, if the indicator 103a of the parameter change operator 103 is in the state of pointing the scale mark of 1, the CPU 201 sets the first singing voice information as the parameters to be used for emitting a singing voice. If the indicator 103a of the parameter change operator 103 is in the state of pointing the scale mark of 2, the CPU 201 sets the second singing voice information as the parameters to be used for emitting a singing voice. If the indicator 103a of the parameter change operator 103 is in the state of being located between the scale mark of 1and the scale mark of 2, the CPU 21 generates singing voice information on the basis of the first singing voice information and the second singing voice information according to the position, stores the generated singing voice information in the RAM 203, and sets the generated singing voice information as the parameters to be used for emitting a singing voice.

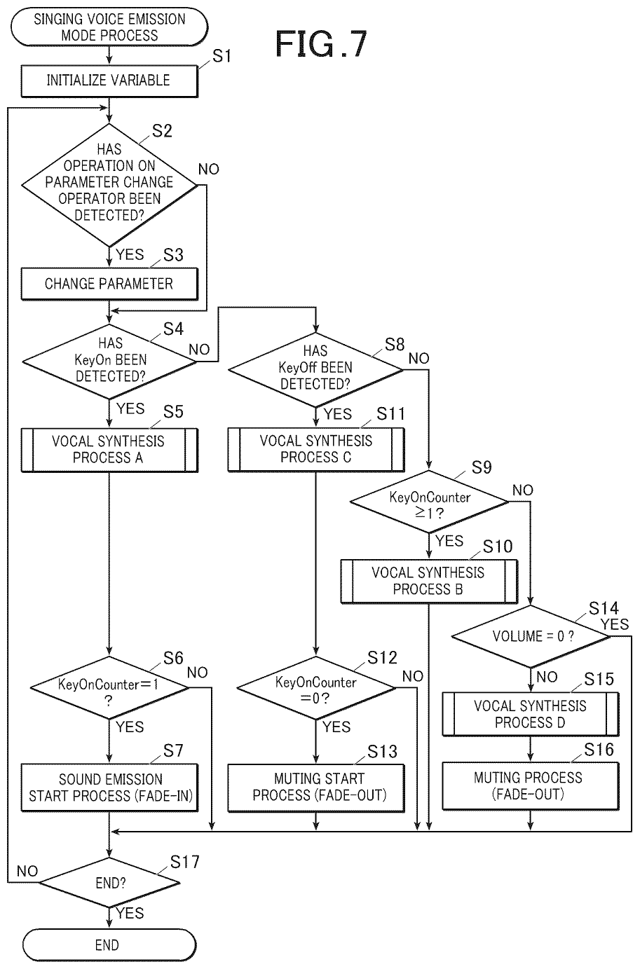

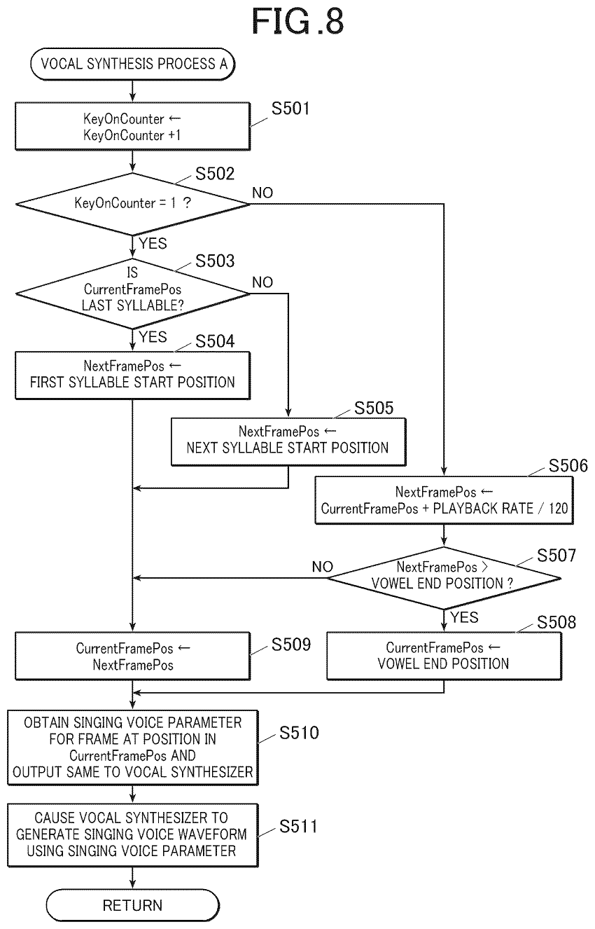

Next, the CPU 201 starts the singing voice emission mode process (shown in FIG. 7) described below to detect the state of the keyboard 101 on the basis of the performance operation information from the key scanner 206 and perform vocal synthesis processes A to D (shown in FIG. 8 to FIG. 11), thereby identifying a frame to be pronounced (the sound of which is to be emitted). In the case where the first mode is set, the CPU 201 reads, from the RAM 203, the fundamental frequency F0 parameter and the spectrum parameter of the set singing voice information for the identified frame, and outputs the parameters together with the pitch information on the pressed key to the vocal synthesizer 205. The vocal synthesizer 205 generates singing voice waveform data on the basis of the input pitch information, fundamental frequency FO parameter and spectrum parameter, and outputs the data to the D/A converter 212. In the case where the second mode is set, the CPU 201 reads, from the RAM 203, the spectrum parameter of the set singing voice information for the identified frame, and outputs the parameter to the vocal synthesizer 205. In addition, the CPU 201 outputs the pitch information on the pressed key to the sound source 204. The sound source 204 reads, from the waveform ROM, waveform data corresponding to the input pitch information with a preset tone as utterance sound source waveform data, and outputs the data to the vocal synthesizer 205. The vocal synthesizer 205 generates singing voice waveform data on the basis of the input utterance sound source waveform data and spectrum parameter, and outputs the data to the D/A converter 212.

The singing voice waveform data output to the D/A converter 212 is converted to an analog sound signal, and the analog sound signal is amplified by the amplifier 213 and output from the speaker 214.

Hereinafter the singing voice emission mode process will be described.

FIG. 7 is a flowchart showing flow of the singing voice emission mode process. The singing voice emission mode process is performed by the CPU 201 and a program(s) stored in the ROM 202 working together, for example, when setting of the singing voice information (group of singing voice parameters) to be used for emitting a singing voice finishes.

First, the CPU 201 initializes variables that are used in the vocal synthesis processes A to D (Step S1). Next, the CPU 201 determines on the basis of an input from the key scanner 206 whether an operation on the parameter change operator 103 has been detected (Step S2).

If the CPU 201 determines that an operation on the parameter change operator 103 has been detected (Step S2; YES), the CPU 201 changes, according to the position of the indicator 103a of the parameter change operator 103, the singing voice information (group singing of voice parameters) to be used for emitting a singing voice (Step S3) and proceeds to Step S4.

For example, if the indicator 103a of the parameter change operator 103 is changed to point the scale mark of 1, settings of the parameters to be used for emitting a singing voice are changed to the first singing voice information. If the indicator 103a of the parameter change operator 103 is changed to point the scale mark of 2, settings of the parameters to be used for emitting a singing voice are changed to the second singing voice information. If the indicator 103a of the parameter change operator 103 is changed to be located between the scale mark of 1 and the scale mark of 2, singing voice information is generated on the basis of the first singing voice information and the second singing voice information (e.g., by synthesizing the first singing voice information and the second singing voice information in accordance with the ratio of the rotation angle of the indicator 103a from the scale mark of 1 and the rotation angle thereof from the scale mark of 2) and stored in the RAM 203, and settings of the parameters to be used for emitting a singing voice are changed to the generated singing voice information. This makes it possible to change the voice tone even during emission of the singing voice (during a performance).

If the CPU 201 determines that no operation on the parameter change operator 103 has been detected (Step S2; NO), the CPU 201 proceeds to Step S4.

In Step S4, the CPU 201 determines on the basis of the performance operation information input from the key scanner 206 whether a key press operation (KeyOn) on the keyboard 101 has been detected (Step S4).

If the CPU 201 determines that KeyOn has been detected (Step S4; YES), the CPU 201 performs the vocal synthesis process A (Step S5).

FIG. 8 is a flowchart showing flow of the vocal synthesis process A. The vocal synthesis process A is performed by the CPU 201 and a program stored in the ROM 202 working together.

In the vocal synthesis process A, first, the CPU 201 sets “KeyOnCounter+1” to KeyOnCounter (Step S501).

The KeyOnCounter is a variable that stores the number of keys currently pressed (number of operation elements being operated).

Next, the CPU 201 determines whether “KeyOnCounter=1” holds (Step S502).

In other words, the CPU 201 determines whether the detected key press operation has been made in the state in which the other operation elements are not pressed.

If the CPU 201 determines that “KeyOnCounter=1” holds (Step S502; YES), the CPU 201 determines whether CurrentFramePos is the frame position of the last syllable (Step S503).

The CurrentFramePos is a variable that stores the frame position of the current pronunciation (sound emission) target frame, and until it is replaced by the frame position of the next pronunciation target frame (e.g., in FIG. 8, until Step S508 or Step S509 is performed), stores the frame position of the last pronounced frame.

If the CPU 201 determines that Current FramePos is the frame position of the last syllable (Step S503; YES), the CPU 201 sets the syllable start position of the first syllable to NextFramePos that is a variable that stores the frame position of the next pronunciation target frame (Step S504).

The CPU 201 then sets NextFramePos to Current FramePos (Step S509) and proceeds to Step S510.

In other words, if the last pronounced frame is of the last syllable, there is no syllable next to the last pronounced syllable, and therefore the position of the pronunciation target frame is advanced to the frame at the first syllable start position.

If the CPU 201 determines that CurrentFramePos is not the frame position of the last syllable (Step S503; NO), the CPU 201 sets the syllable start position of the next syllable to NextFramePos (Step S505).

The CPU 201 then sets NextFramePos to CurrentFramePos (Step S509) and proceeds to Step S510.

In other words, if the last pronounced frame is not of the last syllable, the position of the pronunciation target frame is advanced to the syllable start position of the next syllable.

If the CPU 201 determines that “KeyOnCounter=1” does not hold (Step S502; NO), the CPU 201 sets “CurrentFramePos +Playback Rate/120” to NextFramePos (Step S507).

The “120” is a default tempo value, but the default tempo value is not limited thereto. The playback rate is a value preset by the user. For example, if the playback rate is set at 240, the position of the frame to be pronounced next is set at a position two frames forward from the current frame position. If the playback rate is set at 60, the position of the frame to be pronounced next is set at a position 0.5 frame forward from the current frame position.

Next, the CPU 201 determines whether “NextFramePos >Vowel End Position” holds (Step S507). In other words, the CPU 201 determines whether the position of the frame to be pronounced next is beyond the vowel end position of the current pronunciation target syllable (i.e., the vowel end position of the last pronounced syllable).

If the CPU 201 determines that “NextFramePos>Vowel End Position” does not hold (Step S507; NO), the CPU 201 sets NextFramePos to Current FramePos (Step S509) and proceeds to Step S510.

In other words, the frame position of the pronunciation target frame is advanced to NextFramePos.

If the CPU 201 determines that “NextFramePos>Vowel End Position” holds (Step S507; YES), the CPU 201 sets the vowel end position of the current pronunciation target syllable to CurrentFramePos (Step S508) and proceeds to Step S510.

In other words, if NextFramePos is beyond the vowel end position, the frame position of the pronunciation target frame is not advanced to the position in NextFramePos, but maintained at the vowel end position of the last pronounced syllable.

In Step S510, the CPU 201 obtains, from the RAM 203, the singing voice parameter for the frame at the frame position stored in CurrentFramePos among the singing voice information set as the parameters to be used for emitting a singing voice and outputs the parameter to the vocal synthesizer 205 (Step S510), causes the vocal synthesizer 205 to generate singing voice waveform data on the basis of the output singing voice parameter and causes a singing voice (sound) to be output through the D/A converter 212, the amplifier 213 and the speaker 214 (Step S511), and proceeds to Step S6 shown in FIG. 7.

In the case where the first mode is set, the CPU 201 outputs the pitch information on the pressed key to the vocal synthesizer 205 and also reads from the RAM 203 and outputs to the vocal synthesizer 205 the fundamental frequency F0 parameter and the spectrum parameter for the identified frame among the set singing voice information, causes the vocal synthesizer 205 to generate singing voice waveform data on the basis of the output pitch information, fundamental frequency F0 parameter and spectrum parameter, and causes a sound based on the singing voice waveform data to be output (emitted) through the D/A converter 212, the amplifier 213 and the speaker 214. In the case where the second mode is set, the CPU 201 reads from the RAM 203 and outputs to the vocal synthesizer 205 the spectrum parameter for the identified frame among the set singing voice information. In addition, the CPU 201 outputs the pitch information on the pressed key to the sound source 204, and causes the sound source 204 to read from the waveform ROM and output to the vocal synthesizer 205 waveform data corresponding to the input pitch information with a preset tone as utterance sound source waveform data. The CPU 201 then causes the vocal synthesizer 205 to generate singing voice waveform data on the basis of the input utterance sound source waveform data and spectrum parameter, and causes a sound based on the singing voice waveform data to be output through the D/A converter 212, the amplifier 213 and the speaker 214.

In Step S6 shown in FIG. 7, the CPU 201 determines whether “KeyOnCounter=1” holds (Step S6). In other words, the CPU 201 determines whether the key press operation detected this time is a key press operation in the state in which there is no pressed key.

If the CPU 201 determines that “KeyOnCounter=1” holds (Step S6; YES), the CPU 201 controls the amplifier 213 to perform a sound emission start process (fade-in) of the sound based on the generated singing voice waveform data (Step S7) and proceeds to Step S17. The sound emission start process is a process of gradually increasing the volume of the amplifier 213 (fading in) until it reaches a set value. This makes it possible to output (emit) the sound based on the singing voice waveform data generated by the vocal synthesizer 205 through the speaker 214 while gradually making the sound louder. When the volume of the amplifier 213 reaches the set value, the sound emission start process finishes, but the volume of the amplifier 213 is maintained at the set value until a muting start process is performed.

If the CPU 201 determines that “KeyOnCounter=1” does not hold (Step S6; NO), the CPU 201 proceeds to Step S17. In other words, if there is a pressed key(s) at the time of detection of the key press operation this time, the sound emission start process has been started already, and therefore the CPU 201 proceeds to Step S17.

In Step S4, if the CPU 201 determines that KeyOn has not been detected (Step S4; NO), the CPU 201 determines whether release of any key (KeyOff, i.e., release of a key press operation) of the keyboard 101 has been detected (Step S8).

In Step S8, if the CPU 201 determines that KeyOff has not been detected (Step S8; NO), the CPU 201 determines whether “KeyOnCounter≥1” holds (Step S9).

If the CPU 201 determines that “KeyOnCounter≥1” holds (Step S9; YES), the CPU 201 performs the vocal synthesis process B (Step S10).

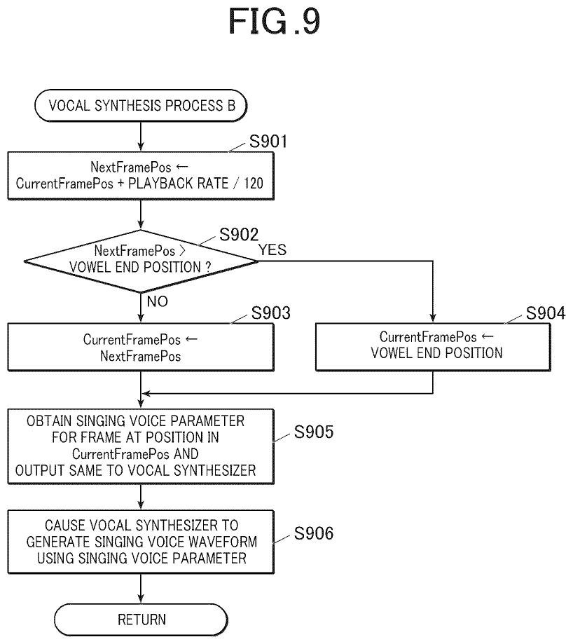

FIG. 9 is a flowchart showing flow of the vocal synthesis process B. The vocal synthesis process B is performed by the CPU 201 and a program stored in the ROM 202 working together.

In the vocal synthesis process B, first, the CPU 201 sets “CurrentFramePos+Playback Rate/120” to NextFramePos (Step S901).

The process of Step S901 is the same as that of Step S506 shown in FIG. 8, the description of which applies to Step S901.

Next, the CPU 201 determines whether “Next FramePos >Vowel End Position” holds (Step S902). In other words, the CPU 201 determines whether NextFramePos is beyond the vowel end position of the current pronunciation target syllable (i.e., the vowel end position of the last pronounced syllable).

If the CPU 201 determines that “NextFramePos >Vowel End Position” does not hold (Step S902; NO), the CPU 201 sets Next FramePos to Current FramePos (Step S903) and proceeds to Step S905.

In other words, if NextFramePos is not beyond the vowel end position, the frame position of the pronunciation target frame is advanced to NextFramePos.

If the CPU 201 determines that “NextFramePos >Vowel End Position” holds (Step S902; YES), the CPU 201 sets the vowel end position of the current pronunciation target syllable to CurrentFramePos (Step S904) and proceeds to Step S905.

In other words, if NextFramePos is beyond the vowel end position, the frame position of the pronunciation target frame is not advanced to the position in NextFramePos, but maintained at the vowel end position of the last pronounced syllable.

In Step S905, the CPU 201 obtains, from the RAM 203, the singing voice parameter for the frame at the frame position stored in CurrentFramePos among the singing voice information set as the parameters to be used for emitting a singing voice and outputs the parameter to the vocal synthesizer 205 (Step S905), causes the vocal synthesizer 205 to generate singing voice waveform data on the basis of the output singing voice parameter and causes a singing voice based thereon to be output through the D/A converter 212, the amplifier 213 and the speaker 214 (Step S906), and proceeds to Step S17 shown in FIG. 7.

The processes of Steps S905 and S906 are the same as those of Steps S510 and S511 shown in FIG. 8, respectively, the descriptions of which apply to Steps S905 and S906, respectively.

In Step S8 shown in FIG. 7, if the CPU 201 determines that KeyOff has been detected (Step S8; YES), the CPU 201 performs the vocal synthesis process C (Step S11).

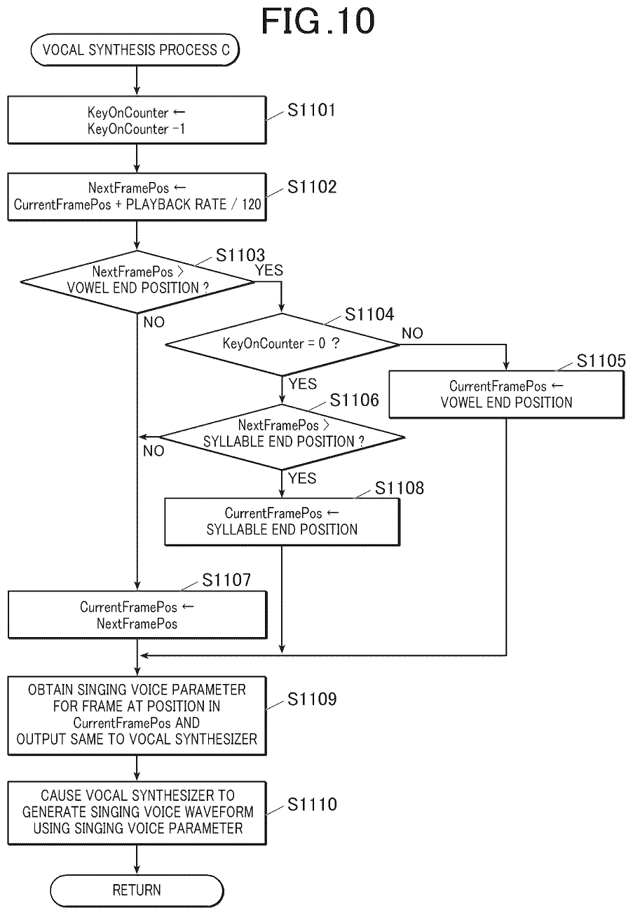

FIG. 10 is a flowchart showing flow of the vocal synthesis process C. The vocal synthesis process C is performed by the CPU 201 and a program stored in the ROM 202 working together.

In the vocal synthesis process C, first, the CPU 201 sets “KeyOnCounter−1” to KeyOnCounter (Step S1101).

Next, the CPU 201 sets “CurrentFramePos +Playback Rate/120” to NextFramePos (Step S1102).

The process of Step S1102 is the same as that of Step S506 shown in FIG. 8, the description of which applies to Step S1102.

Next, the CPU 201 determines whether “Next FramePos>Vowel End Position” holds (Step S1103). In other words, the CPU 201 determines whether NextFramePos is beyond the vowel end position of the current pronunciation target syllable (i.e., the vowel end position of the last pronounced syllable).

If the CPU 201 determines that “NextFramePos>Vowel End Position” does not hold (Step S1103; NO), the CPU 201 sets NextFramePos to Current FramePos (Step S1107) and proceeds to Step S1109.

In other words, if NextFramePos is not beyond the vowel end position, the frame position of the pronunciation target frame is advanced to NextFramePos.

If the CPU 201 determines that “NextFramePos>Vowel End Position” holds (Step S1103; YES), the CPU 201 determines whether “KeyOnCounter=0” holds (i.e., whether all the keys of the keyboard 101 are in the state of being released) (Step S1104).

If the CPU 201 determines that “KeyOnCounter=0” does not hold (Step S1104; NO), the CPU 201 sets the vowel end position of the current pronunciation target syllable to CurrentFramePos (Step S1105) and proceeds to Step S1109.

In other words, if NextFramePos is beyond the vowel end position, and not all the keys of the keyboard 101 are in the state of being released (there is a pressed key(s)), the frame position of the pronunciation target frame is not advanced to NextFramePos, but maintained at the vowel end position of the last pronounced syllable.

If the CPU 201 determines that “KeyOnCounter=0” holds (Step S1104; YES), the CPU 201 determines whether “Next FramePos >Syllable End Position” holds (Step S1106).

In other words, the CPU 201 determines whether NextFramePos is beyond the syllable end position of the current pronunciation target syllable (i.e., the syllable end position of the last pronounced syllable).

If the CPU 201 determines that “NextFramePos>Syllable End Position” does not hold (Step S1106; NO), the CPU 201 sets NextFramePos to CurrentFramePos (Step S1107) and proceeds to Step S1109.

In other words, if all the keys of the keyboard 101 are in the state of being released, and NextFramePos is not beyond the syllable end position, the frame position of the pronunciation target frame is advanced to Next FramePos.

If the CPU 201 determines that “NextFramePos>Syllable End Position” holds (Step S1106; YES), the CPU 201 sets the syllable end position to CurrentFramePos (Step S1108) and proceeds to Step S1109.

In other words, if all the keys of the keyboard 101 are in the state of being released, and NextFramePos is beyond the syllable end position, the frame position of the pronunciation target frame is not advanced to NextFramePos, but maintained at the syllable end position of the last pronounced syllable.

In Step S1109, the CPU 201 obtains, from the RAM 203, the singing voice parameter for the frame at the frame position stored in CurrentFramePos among the singing voice information set as the parameters to be used for emitting a singing voice and outputs the parameter to the vocal synthesizer 205 (Step S1109), causes the vocal synthesizer 205 to generate singing voice waveform data on the basis of the output singing voice parameter and causes a singing voice based thereon to be output through the D/A converter 212, the amplifier 213 and the speaker 214 (Step S1110), and proceeds to Step S12 shown in FIG. 7.

The processes of Steps S1109 and S1110 are the same as those of Steps S510 and S511 shown in FIG. 8, respectively, the descriptions of which apply to Steps S1109 and S1110, respectively.

In Step S12 shown in FIG. 7, the CPU 201 determines whether “KeyOnCounter=0” holds (release of all the keys of the keyboard 101 has been detected) (Step S12).

If the CPU 201 determines that “KeyOnCounter=0” does not hold (release of all the keys of the keyboard 101 has not been detected) (Step S12; NO), the CPU 201 proceeds to Step S17.

If the CPU 201 determines that “KeyOnCounter=0” holds (release of all the keys of keyboard 101 has been detected) (Step S12; YES), the CPU 201 controls the amplifier 213 to perform the muting start process (fade-out start) (Step S13) and proceeds to Step S17.

The muting start process is a process of starting a muting process of gradually reducing the volume of the amplifier 213 until it reaches zero. By the muting process, the sound based on the singing voice waveform data generated by the vocal synthesizer 205 is output through the speaker 214 with the volume being gradually reduced.

In Step S9, if the CPU 201 determines that “KeyOnCounter≥1” does not hold (Step S9; NO), namely, determines that all the keys of the keyboard 101 are in the state of being released, the CPU 201 determines whether the volume of the amplifier 213 is zero (Step S14).

If the CPU 201 determines that the volume of the amplifier 213 is not zero (Step S14; NO), the CPU 201 performs the vocal synthesis process D (Step S15).

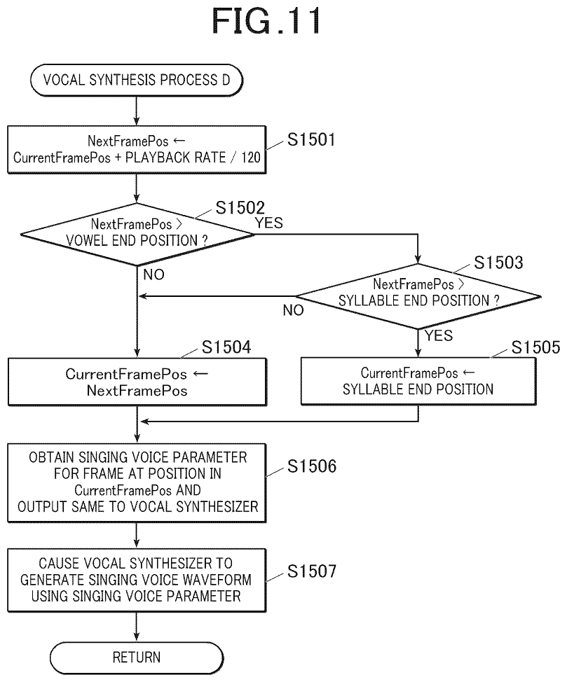

FIG. 11 is a flowchart showing flow of the vocal synthesis process D. The vocal synthesis process D is performed by the CPU 201 and a program stored in the ROM 202 working together.

In the vocal synthesis process D, first, the CPU 201 sets “Current FramePos+Playback Rate/120” to NextFramePos (Step S1501).

The process of Step S1501 is the same as that of Step S506 shown in FIG. 8, the description of which applies to Step S1501.

Next, the CPU 201 determines whether “Next FramePos>Vowel End Position” holds (Step S1502). In other words, the CPU 201 determines whether NextFramePos is beyond the vowel end position of the current pronunciation target syllable (i.e., the vowel end position of the last pronounced syllable).

If the CPU 201 determines that “NextFramePos>Vowel End Position” does not hold (Step S1502; NO), the CPU 201 sets NextFramePos to CurrentFramePos (Step S1504) and proceeds to Step S1506.

In other words, if NextFramePos is not beyond the vowel end position, the frame position of the pronunciation target frame is advanced to NextFramePos.

If the CPU 201 determines that “NextFramePos>Vowel End Position” holds (Step S1502; YES), the CPU 201 determines whether “NextFramePos>Syllable End Position” holds (Step S1503).

In other words, the CPU 201 determines whether NextFramePos is beyond the syllable end position of the current pronunciation target syllable (i.e., the syllable end position of the last pronounced syllable).

If the CPU 201 determines that “Next FramePos>Syllable End Position” does not hold (Step S1503; NO), the CPU 201 sets NextFramePos to CurrentFramePos (Step S1504) and proceeds to Step S1506. In other words, if Next FramePos is not beyond the syllable end position, the frame position of the pronunciation target frame is advanced to Next FramePos.

If the CPU 201 determines that “Next FramePos>Syllable End Position” holds (Step S1503; YES), the CPU 201 sets the syllable end position to CurrentFramePos (Step S1505) and proceeds to Step S1506.

In other words, if NextFramePos is beyond the syllable end position, the frame position of the pronunciation target frame is not advanced to NextFramePos, but maintained at the syllable end position of the last pronounced syllable.

In Step S1506, the CPU 201 obtains, from the RAM 203, the singing voice parameter for the frame at the frame position stored in CurrentFramePos among the singing voice information set as the parameters to be used for emitting a singing voice and outputs the parameter to the vocal synthesizer 205 (Step S1506), causes the vocal synthesizer 205 to generate singing voice waveform data on the basis of the output singing voice parameter and causes a singing voice based thereon to be output through the D/A converter 212, the amplifier 213 and the speaker 214 (Step S1507), and proceeds to Step S16 shown in FIG. 7.

The processes of Steps S1506 and S1507 are the same as those of Steps S510 and S511 shown in FIG. 8, respectively, the descriptions of which apply to Steps S1506 and S1507, respectively.

In Step S16 shown in FIG. 7, the CPU 201 controls the amplifier 213 to perform the muting process (fade-out) (Step S16) and proceeds to Step S17.

In Step S14, if the CPU 201 determines that the volume of the amplifier 213 is zero (Step S14; YES), the CPU 201 proceeds to Step S17.

In Step S17, the CPU 201 determines whether an instruction to end the singing voice emission mode has been made (Step S17).

For example, if the singing voice emission mode switch is pressed to make an instruction to shift to the normal mode, the CPU 201 determines that an instruction to end the singing voice emission mode has been made.

If the CPU 201 determines that an instruction to end the singing voice emission mode has not been made (Step S17; NO), the CPU 201 returns to Step S2.

If the CPU 201 determines that an instruction to end the singing voice emission mode has been made (Step S17; YES), the CPU 201 ends the singing voice emission mode process.

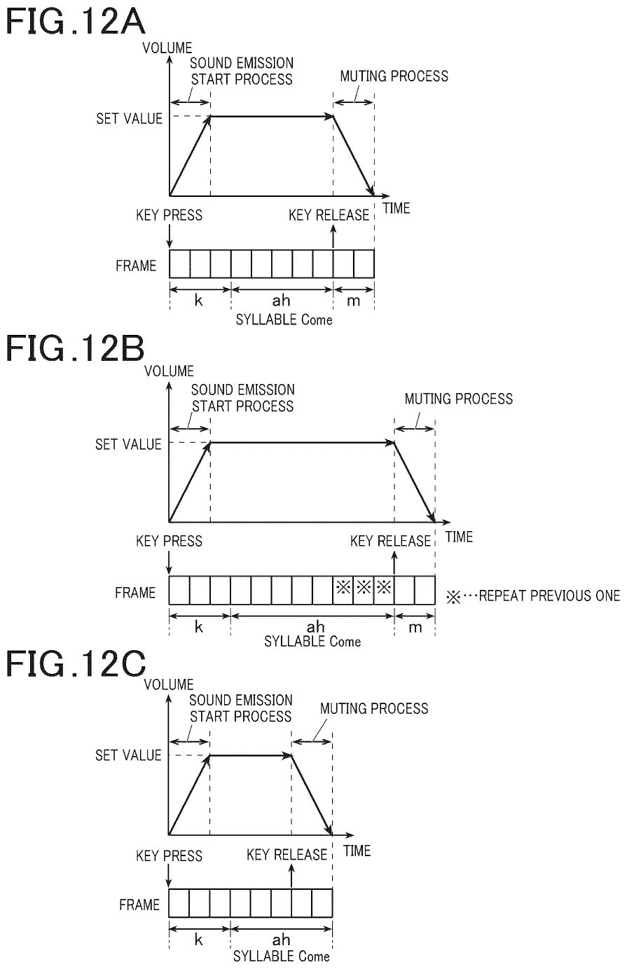

FIG. 12A to FIG. 12C each show a graph and a schematic view in a case where a syllable of “Come” is pronounced in response to an operation (key press operation (KeyOn)) on the keyboard 101 by the above-described singing voice emission mode process, wherein the graph shows change in volume from when key press (in the state in which no keys are pressed) is detected until when key release (KeyOff) is detected and the volume becomes zero, and the schematic view shows frame positions that are used for pronunciation at respective timings in the graph. FIG. 12A shows the graph and the schematic view of a case where key release (release of all keys) is detected at the timing of the end position of a vowel of ah. FIG. 12B shows the graph and the schematic view of a case where key release (release of all keys) is detected after a time for three frames elapses from the timing of the end position of the vowel of ah. FIG. 12C shows a case where key release (release of all keys) is detected at a timing before the end position of the vowel of ah.

As shown in FIG. 12B, after pronunciation of the syllable based on the singing voice parameter for the syllable start frame (first frame in FIG. 12B) is started by detection of key press, if the key press continues even after the frame position advances to the frame (vowel frame) at the vowel end position in the vowel section (section for “ah” in FIG. 12B) included in the syllable being pronounced (i.e., even after start of the pronunciation of the vowel based on the singing voice parameter for the frame at the vowel end position), the pronunciation of the vowel based on the singing voice parameter for the frame at the vowel end position continues until key release (release of all keys) is detected. As shown in FIG. 12C, after pronunciation of the syllable based on the singing voice parameter for the syllable start frame (first frame in FIG. 12C) is started by detection of key press, if key release (release of all keys) is detected before the frame position advances to the vowel end position, the muting process is started immediately and performed while the position of the frame used for the singing voice parameter is advanced.

This enables natural pronunciation of a syllable(s) at a length(s) corresponding to a user operation(s) on the keyboard 101.

In the conventional singing voice emission technique with an electronic musical instrument (e.g., Patent Literature 1), pieces of audio information, which are waveform data pieces of a plurality of utterance units, are joined together for syllable-by-syllable pronunciation and loop playback in response to an operation, making it difficult to emit a natural singing voice. Further, since audio information, in which waveform data pieces of a plurality of utterance units are chronologically sequenced, needs to be stored, a large memory capacity is required. In the electronic musical instrument 2 of this embodiment, if key press continues even after start of pronunciation of a vowel based on the frame at the vowel end position of a syllable, singing voice waveform data is generated and pronounced using the singing voice parameter for the frame at the vowel end position among the singing voice parameters generated by the learned model that has learned a human singing voice by machine learning. This makes it possible to emit a more natural sound (singing voice), not an awkward one as in the case where waveforms of a vowel are joined together. Further, since waveform data pieces of a plurality of utterance units do not need to be stored in the RAM 203, the memory capacity can be smaller as compared with the conventional singing voice emission technique.

Further, since the conventional singing voice emission technique with an electronic musical instrument is for playing waveform data back, sound emission is performed with a fixed voice tone, and the voice tone cannot be changed during the playback. Meanwhile, in the electronic musical instrument 2 of this embodiment, since sound emission is performed by generating sound waveforms using singing voice parameters, the voice tone of a singing voice can be changed during emission of the singing voice (during a performance) in response to a user operation on the parameter change operator 103.

As described above, according to the CPU 201 of the electronic musical instrument 2, in a case where after sound emission (pronunciation) of a syllable based on a parameter for a syllable start frame is started in response to detection of a key press operation on a key of the keyboard 101, a state in which a pressed key is present continues even after start of sound emission of a vowel based on a parameter for a vowel frame in a vowel section included in the syllable, the CPU 201 causes the sound emission of the vowel based on the parameter for the vowel frame to continue until the pressed key is released (i.e., until key release is detected). More specifically, the CPU 201 outputs a singing voice parameter for a vowel frame to the vocal synthesizer 205 of the electronic musical instrument 2, causes the vocal synthesizer 205 to generate sound waveform data based on the singing voice parameter, and causes a sound based on the sound waveform data to be emitted.

This makes it possible to emit a more natural sound in response to an operation(s) on an electronic musical instrument with a smaller memory capacity.

Further, as the singing voice parameters that are used for the sound emission of the syllable, singing voice parameters inferred by a learned model generated by machine learning of a human (singer) voice are used. This enables expressive sound emission retaining the singer's natural phoneme-level pronunciation nuances.

Further, in response to an operation on the parameter change operator 103 made by a user at a timing including a timing during a performance, the CPU 201 changes the singing voice parameters for the sound emission of the syllable to singing voice parameters for another tone. This makes it possible to change the tone of a singing voice even during a performance (during emission of the singing voice).

The described contents of the above embodiment are not limitations but some preferable examples of the information processing device, the electronic musical instrument, the electronic musical instrument system, the method and the program of the present invention.

For example, in the above embodiment, the information processing device of the present invention is a component included in the electronic musical instrument 2, but not limited thereto. For example, the functions of the information processing device of the present invention may be provided in an external device (e.g., the above-described terminal device 3 (PC (Personal Computer), tablet terminal, smartphone, etc.)) that is connected to the electronic musical instrument 2 through a wired or wireless communication interface.

Further, in the above embodiment, the learned model 302a and the learned model 302b are provided in the terminal device 3, but may be provided in the electronic musical instrument 2. Then, in the electronic musical instrument 2, the learned model 302a and the learned model 302b may each infer the singing voice information on the basis of input lyrics data and pitch data.

Further, in the above embodiment, pronunciation of a syllable is started when a key press operation on one key is detected in the state in which no keys of the keyboard 101 are operated, but the key press operation as a trigger for starting pronunciation of a syllable is not limited thereto. For example, pronunciation of a syllable may be started when a key press operation on a key for a melody (top note) is detected.

Further, in the above embodiment, the electronic musical instrument 2 is an electronic keyboard instrument, but not limited thereto. The electronic musical instrument may be another electronic musical instrument, such as an electronic string instrument or an electronic wind instrument, for example.

Further, in the above embodiment, the computer-readable medium for the program(s) of the present invention is, as an example, a semiconductor memory, such as a ROM, or a hard disk, but not limited thereto. As the computer-readable medium, an SSD or a portable recording medium, such as a CD-ROM, is applicable. Further, medium that provides data of the program(s) of the present invention via a communication line, a carrier wave is applicable.

The detailed configuration and operation of each of the electronic musical instrument, the information processing device and the electronic musical instrument system can be changed appropriately without departing from the scope of the present invention.

Although an embodiment(s) of the present invention has been described above, the technical scope of the present invention is not limited to the embodiment described above, but defined on the basis of claims. Further, the technical scope of the present invention includes the scope of equivalents with changes from the scope of claims added, the changes being irrelevant to the essence of the present invention.

The entire disclosure of Japanese Patent Application No. 2022-006321 filed on Jan. 19, 2022, including the description, claims, drawings and abstract, is incorporated in the present application as it is.

### INDUSTRIAL APPLICABILITY

The present invention relates to control of an electronic musical instrument and has industrial applicability.

### REFERENCE SIGNS LIST

1 Electronic Musical Instrument System
2 Electronic Musical Instrument
101 Keyboard
102 Switch Panel
103 Parameter Change Operator
104 LCD
201 CPU
202 ROM
203 RAM
204 Sound Source
205 Vocal Synthesizer
206 Rey Scanner
208 Communicator
209 Bus
210 Timer
211 D/A Converter
212 D/A Converter
213 Amplifier
214 Speaker
3 Terminal Device
301 CPU
302 ROM
302a Learned Model
302b Learned Model
303 RAM
304 Storage
305 Operation Unit
306 Display
307 Communicator
308 Bus

1. An information processing device comprising:
a controller that,
in response to detection of an operation on an operation element, causes sound emission of a syllable to start based on a parameter for a syllable start frame, and
in a case where the operation continues even after start of sound emission of a vowel based on a parameter for a vowel frame in a vowel section included in the syllable, causes the sound emission of the vowel based on the parameter for the vowel frame to continue until the operation is released.

2. The information processing device according to claim 1, wherein the controller outputs the parameters to a vocal synthesizer of an electronic musical instrument, causes the vocal synthesizer to generate sound waveform data based on the parameters, and causes a sound based on the sound waveform data to be emitted.

3. The information processing device according to claim 1, wherein the parameters are parameters inferred by a learned model generated by machine learning of a human voice.

4. The information processing device according to claim 1, wherein the parameters each include a spectrum parameter.

5. The information processing device according to claim 1, wherein in response to a change instructing operation for a tone of a sound to be emitted, the change instructing operation being made by a user at a timing including a timing during a performance, the controller changes the parameters to parameters for another tone.

6. The information processing device according to claim 1, wherein the case where the operation on the operation element continues includes a case where a pressed key is present in an electronic keyboard instrument, and
wherein the operation being released includes a state in which all the pressed key is released and no key is pressed in the electronic keyboard instrument.

7. An electronic musical instrument comprising:
the information processing device according to claim 1; and
a plurality of operation elements.

8. An electronic musical instrument system comprising:
the information processing device according to claim 1; and
an electronic musical instrument including a plurality of operation elements.

9. A method that is performed by a controller of an information processing device, comprising:
in response to detection of an operation on an operation element, causing sound emission of a syllable to start based on a parameter for a syllable start frame; and
in a case where the operation continues even after start of sound emission of a vowel based on a parameter for a vowel frame in a vowel section included in the syllable, causing the sound emission of the vowel based on the parameter for the vowel frame to continue until the operation is released.

10. A non-transitory computer-readable storage medium storing a program that causes a controller of an information processing device to perform a process comprising:
in response to detection of an operation on an operation element, causing sound emission of a syllable to start based on a parameter for a syllable start frame; and
in a case where the operation continuous even after start of sound emission of a vowel based on a parameter for a vowel frame in a vowel section included in the syllable, causing the sound emission of the vowel based on the parameter for the vowel frame to continue until the operation is released.

11. The method according to claim 9, further comprising:
outputting the parameters to a vocal synthesizer of an electronic musical instrument;
causing the vocal synthesizer to generate sound waveform data based on the parameters; and
causing a sound based on the sound waveform data to be emitted.

12. The method according to claim 9, wherein the parameters are parameters inferred by a learned model generated by machine learning of a human voice.

13. The method according to claim 9, wherein the parameters each include a spectrum parameter.

14. The method according to claim 9, further comprising:
in response to a change instructing operation for a tone of a sound to be emitted, the change instructing operation being made by a user at a timing including a timing during a performance, changing the parameters to parameters for another tone.
